(19) United States
(12) Patent Application Publication
(10) Pub. No.: US 2025/0001847 A1
(43) Pub. Date: Jan. 2, 2025

(54) Hardtop Slider Device and System

(71) Applicant: Brian Goldwitz, WATERBURY, CT (US)

(72) Inventor: Brian Goldwitz, WATERBURY, CT (US)

(21) Appl. No.: 18/648,447

(22) Filed: Apr. 28, 2024

Related U.S. Application Data
(60) Provisional application No. 63/462,943, filed on Apr. 28, 2023.

(51) Int. Cl. B60J 7/04; B60J 1/18

(52) U.S. Cl. CPC B60J 7/041; B60J 1/1838

(57) ABSTRACT

The current invention is a double hard top hinge and System. It allows for the easy of moving sliding and storing a hard top on a vehicle like an SUV or a Jeep®. The system will have a double hinge that will allow the roof panel to be moved on top of a accessory such as a luggage rack this is on top of a vehicle. The panels can be stacked and stored at the same level as the top of the cab.

### RELATED APPLICATIONS

It is a non-provisional of provisional application 63/462,943 filed Apr. 28, 2023 and claims its priority date.

### TECHNICAL FIELD

The technology discussed below relates to a vehicle hardtop storage device and more particularly one that slides back.

### BACKGROUND

People with SUV and jeeps sometimes need a quick and easy place to store a removed panel of their hardtop that is located on their vehicle. This will allow a quick and easy method to reinstall the hardtop panel.

There currently no method for the easy storage of a hard top panel for SUVs that work well and is moved and stored easily and efficiently and can be used as a bed cover.

There is still room for improvement in the art.

### SUMMARY

The current invention is a Hardtop Slider Device and System. It allows for the easy of sliding and storing a hard top on a vehicle like an SUV or a Jeep®. The system will have a slider track that will allow the roof panel to slide away from the top of the cabin of the vehicle. The panels can be stacked and stored at the same level as the top of the cab. The panel can be extended and either slide down to be stored behind the top of the seats or pulled back all the way to serve as a bed cover covering the bed.

These are improvements over the current art.

### DRAWINGS

FIG. 1 show the panels being positioned on the top back of the vehicle;

FIG. 2 shows the panels being slide back towards the back of the vehicle;

FIG. 3 shows a view of the slider mechanism behind the seats;

FIG. 4 shows a view of the sliding mechanism and latch;

FIG. 5 shows the slider attached to the door frame;

FIG. 6 shows the slider support and the panels from the back;

FIG. 7 show the tracks;

FIG. 8 shows the support on the tracks;

FIG. 9 shows the inside upward view of the support;

FIG. 10 shows an inside view of the support;

FIG. 11 a latching system for the panels;

FIG. 12 shows a side view of support;

FIG. 13 shows a side view of the support and the track;

FIG. 14 shows an additional side view of the support and the track;

FIG. 15 shows the support being moved back on the track;

FIG. 16 shows the space between the support and the back of the cab; and

FIG. 17 shows the support being moved back farther.

### DETAILED DESCRIPTION

The illustrations presented herein are, in some instances, not actual views of any particular framing devices or components thereof but may be idealized representations which are employed to describe the present disclosure. Additionally, elements common between figures may retain the same numerical designation.

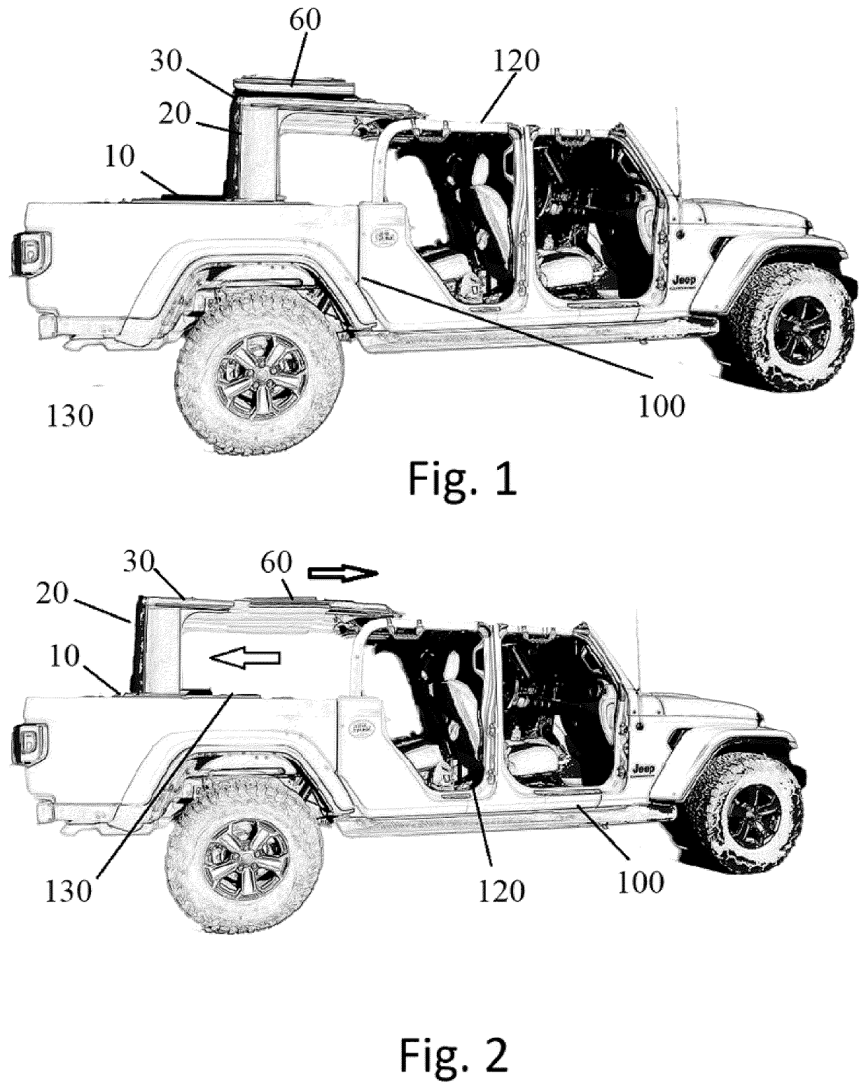

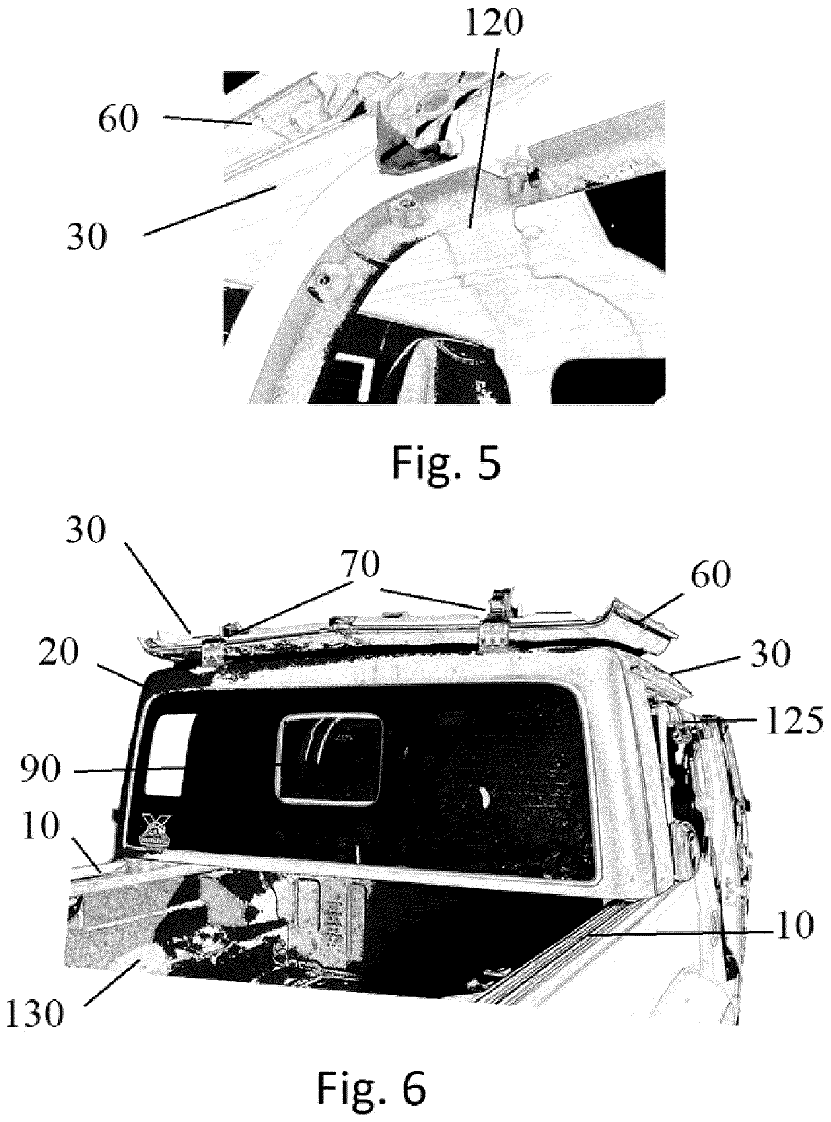

The current invention, as shown in FIGS. 1 through 17, is a Hardtop Slider Device and System. It allows for the easy sliding and storing a hard top panel 60 on a vehicle like an SUV or a Jeep®. The system will have a slider track 10 that will allow the roof panel 60 to slide away from the cabin 120 of the vehicle 100. The panels 60 can folded over and stacked and stored at the same level as the top of the cab 120. The panel 60 can be extended and either slide down to be stored behind the top of the seats or pulled back all the way to serve as an extended bed cover covering the bed 130.

FIG. 1 shows the roof panels 60 where they have been removed from above the cab 120 being positioned on the top back of the vehicle 100 on the top 30 of the support 20. FIG. 2 shows the support 20 being slid back on the track 10 with the roof panels 60 being extended out forming a bed cover. The support 20 can move back sliding on the tracks 10 allowing the panels to extend out on a hinge or on the extender 30 and form a bed cover as shown in FIG. 2.

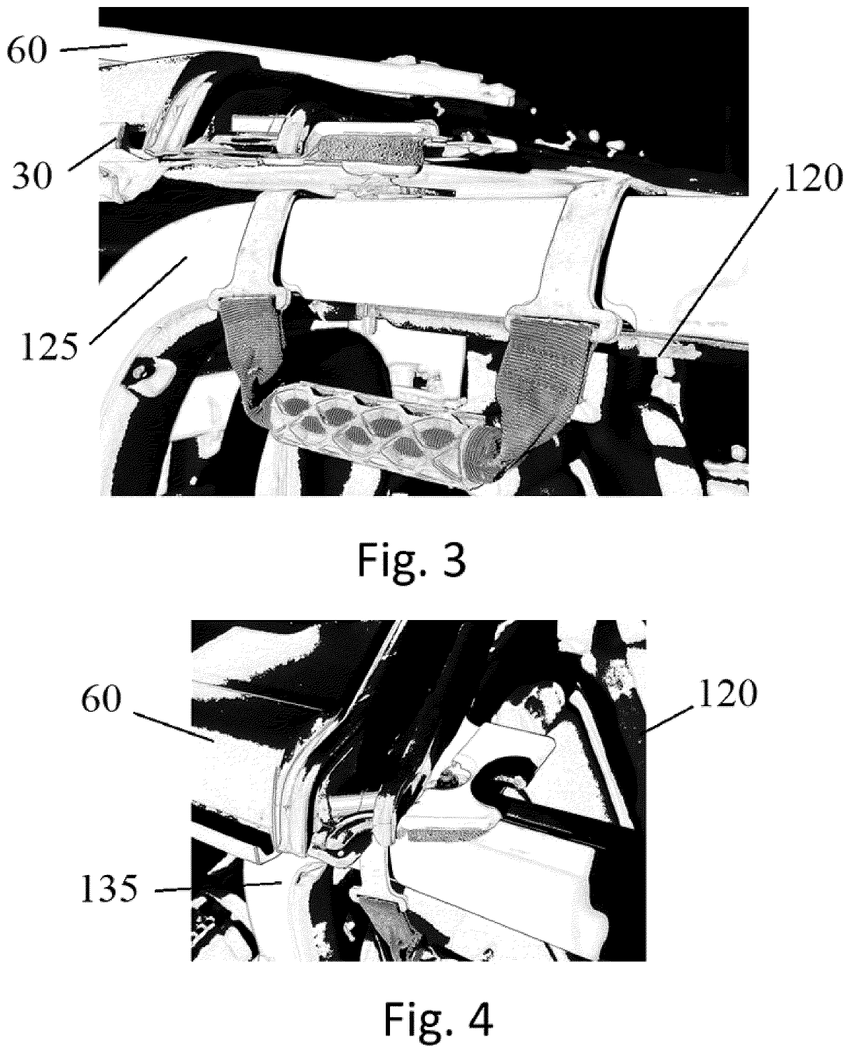

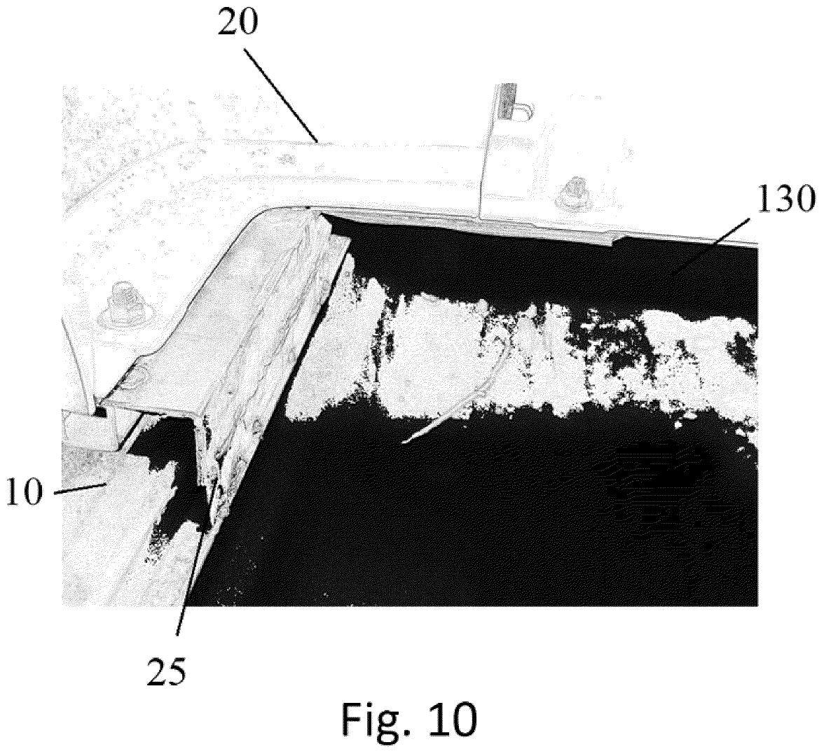

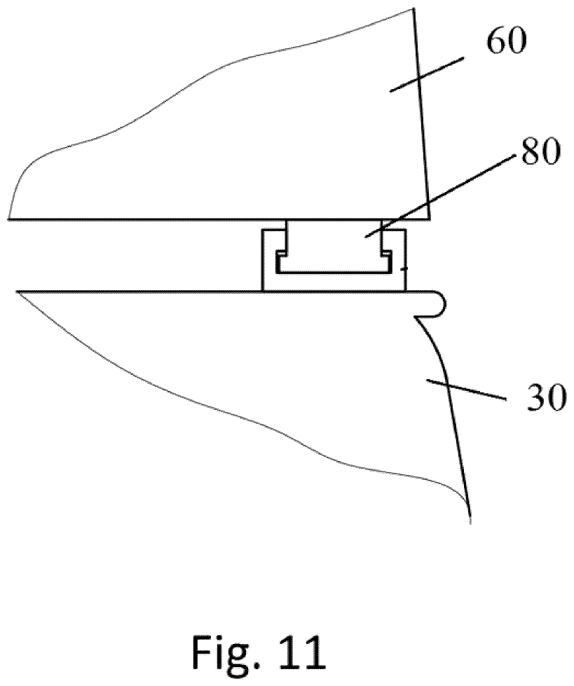

The support 20 can be attached to the upper frame of the vehicle through an attachment means. The support can be attached to the roll bar 135 or the door frame 125 as shown in FIGS. 3, 4 and 5. The attachment means can a hinge as shown in FIG. 11 or it can be attached by clamps or even welding. There can be an extension bar between the top of the support 20 and the frame 135 that expands and provides support for the panels 60 as the support is slide back on the track. The support 20. The support 20 can be attached to the vehicle 100 to the tracks 10 and can use a track slider 25 as shown in FIG. 10.

FIG. 6 shows the slider support 20 with the panels 60 on top. There are latches 70 that hold the panels to the support 20 when in a storage position. The support 20 is positioned on the tracks 10 that are located on the top of the sides of the bed 130. The support 20 runs the width of the bed 130 and is rectangular in shape with a height that is the same or similar to the height of the frame 125 that the panels 60 can be moved parallel to the vehicle 100. The support 20 has two sides and a back with a extender 30 that extends from the front of the support 20. In the preferred embodiment, the support 20 would have a window 90 that would allow the passengers to see behind the vehicle 100. This extender 30 supports the panels 60 as shown in FIG. 6 where the panels 60 are positioned on the top of the extender 30. If an embodiment of the current invention, the extenders 30 connect to the vehicle 100 frame at the same height of the top of the frame and extend using an extension means such as bars that slide inside each other or pivot out extending when the support 20 is slide back on the tracks 10. In other embodiments, the extension 30 only extends to the frame of the vehicle when the support 20 is in a non-extended position and the panel 60 being held by the extension and the frame of the vehicle holding in place for the extended cab.

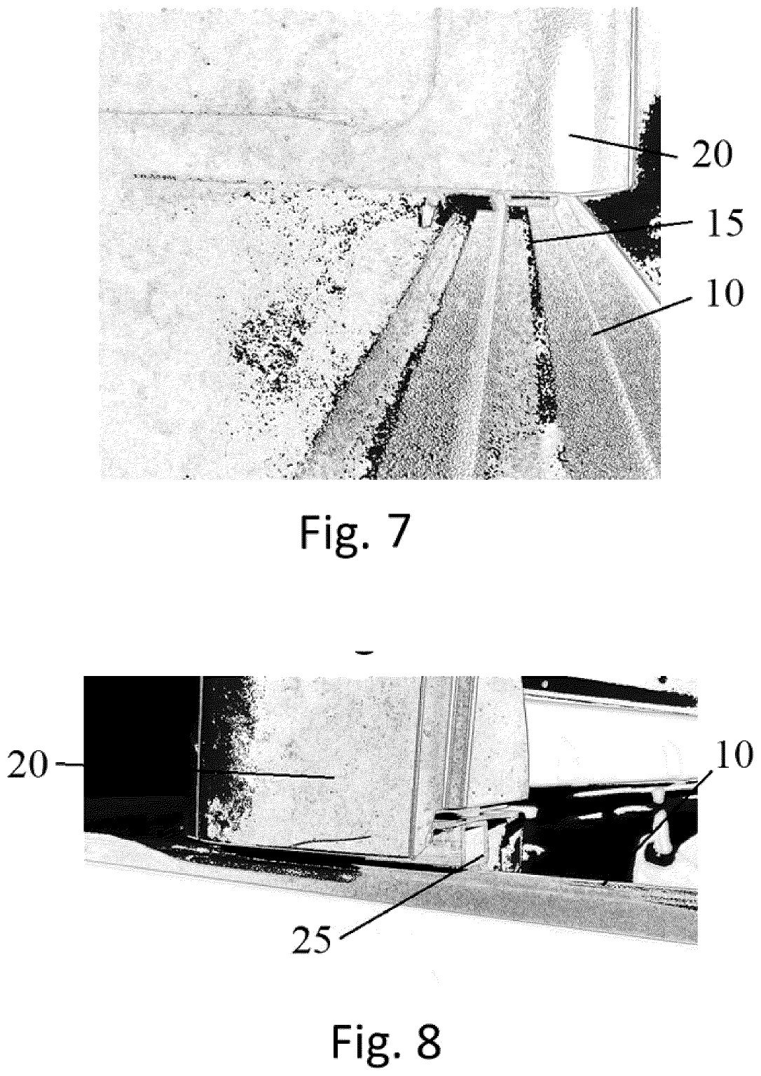

FIG. 7 shows the tracks 10 with track lines 15 that are located on the top of the sides of the bed 130. The support 20 can hook into the track lines 15 to hold it in place when is slides on the track 10.

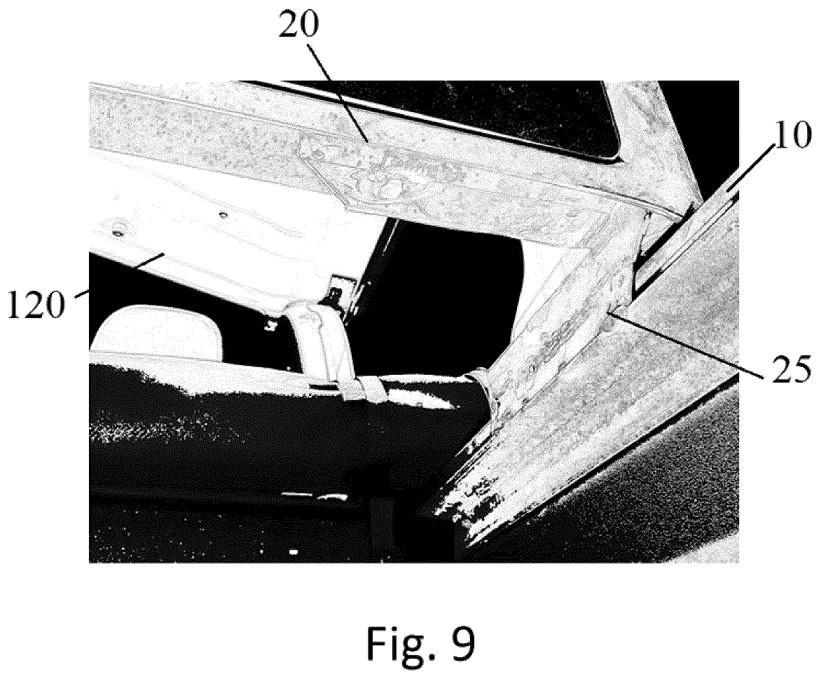

FIG. 8 shows the support 20 attached to the tracks 10. The support 20 moves forward and backward on the tracks 10. FIG. 9 shows the support 20 being attached to the tracks 10 with the support 20 perpendicular to the bed 130.

The support 20 can be attached to a track slider 25 as shown in FIG. 10. This attachment can be by bolts or similar attachment means. The track slider 25 attaches to the track and provides the sliding function through a sliding means such as wheels, ball bearings or a friction reducing surface. This allows for an easier installment of the Hardtop Slider Device and System as the track sliders 25 can be attached first with the support 20 being attached on the track sliders 25 after the track sliders 25 are attached to the track 10. The track sliders and be connected to the track lines 15.

FIG. 11 a latching system 80 for the panels 60 and to attach the extender 30 and the Hardtop Slider Device and System to the vehicle 100.

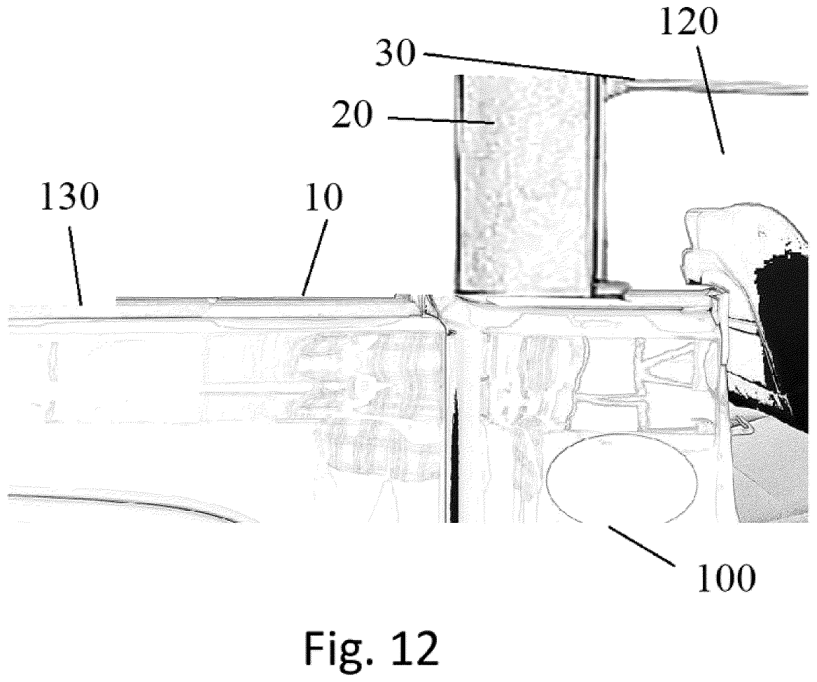

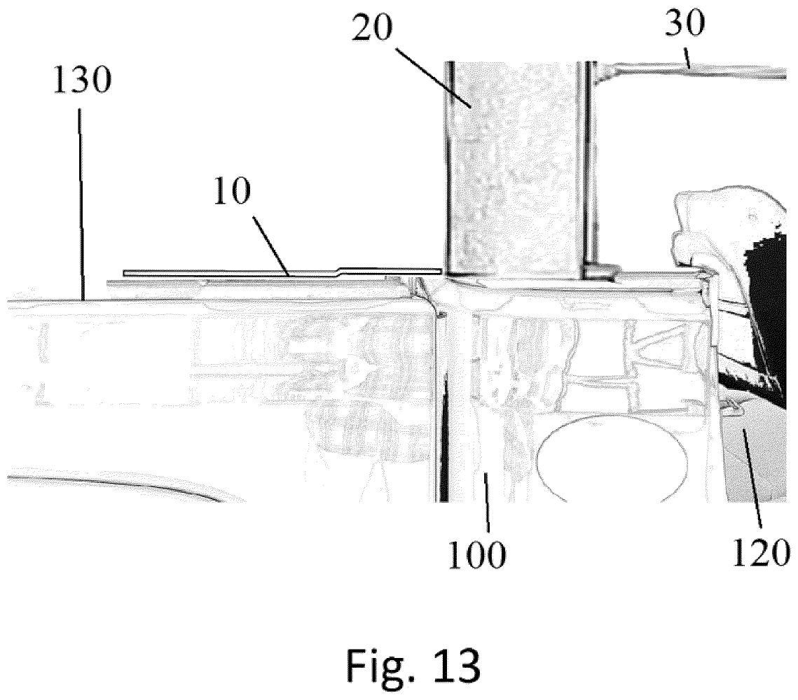

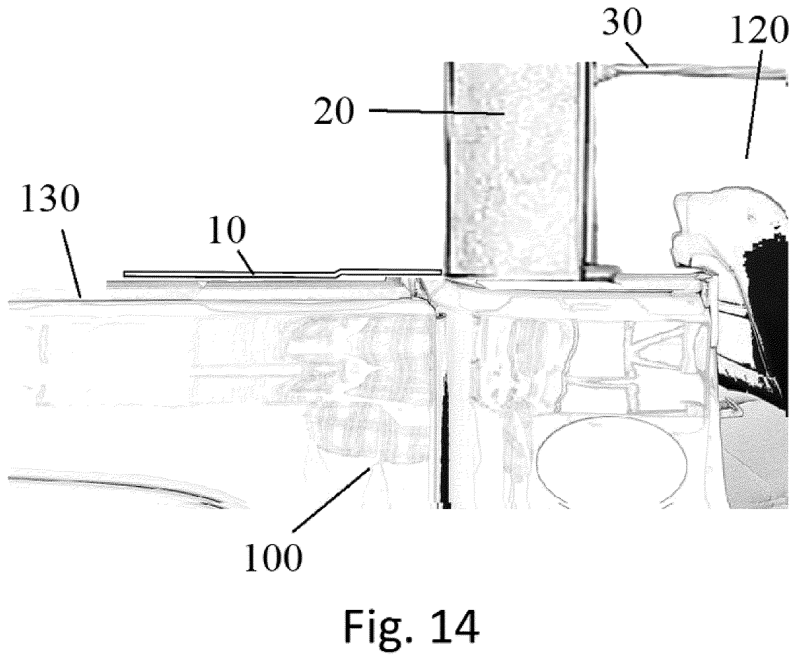

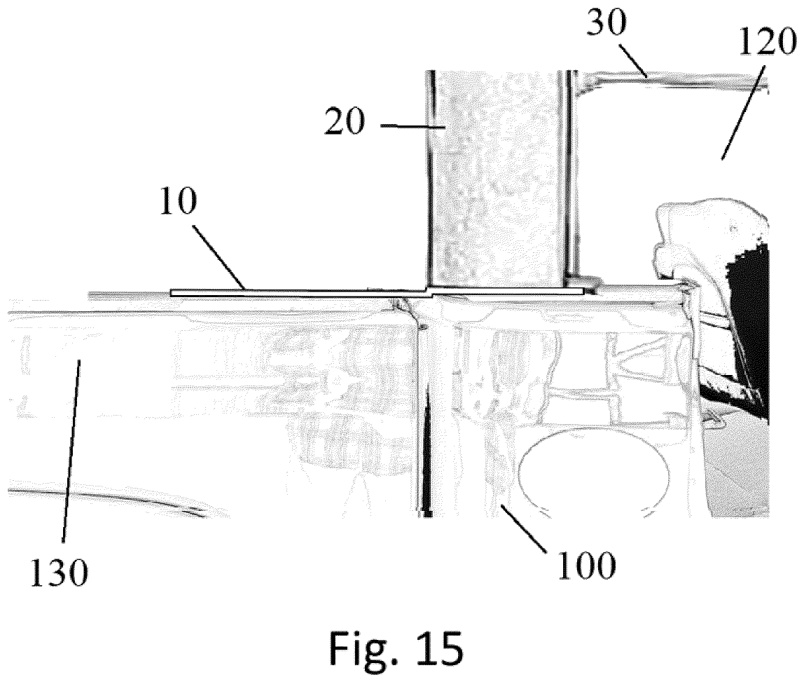

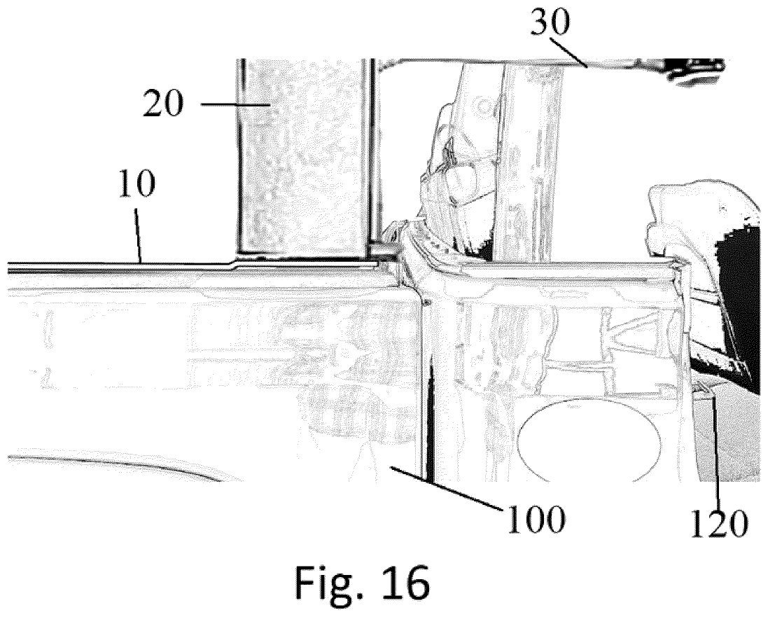

FIG. 12 shows a side view of support 20 attached to the vehicle 100. FIGS. 13 and 14 show a side view of the support 20 and the track 10. The support 20 is slide back on the track 10 as shown in FIG. 15 and FIG. 16. Opening a space between the support 20 and the frame.

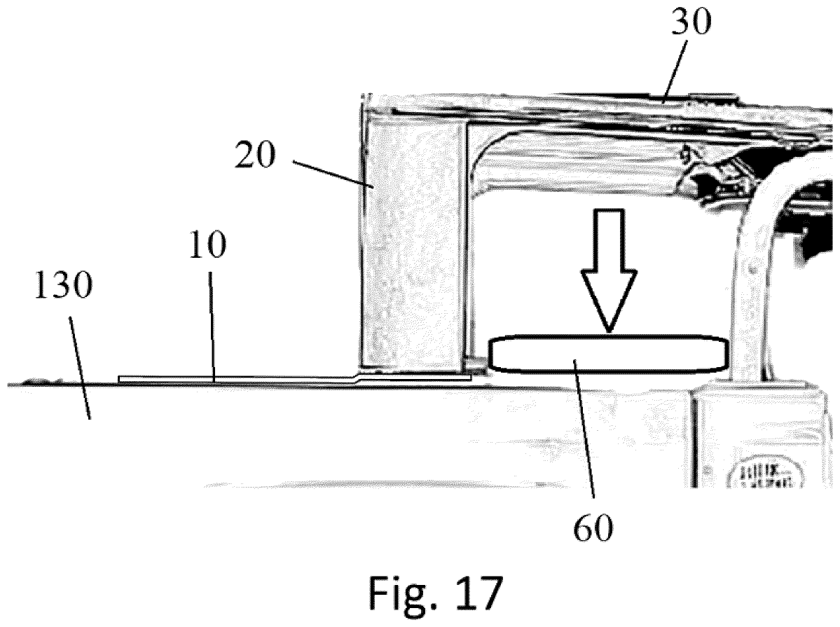

FIG. 17 shows the support slide 25 back on the track 10 and the panels 60 connected to form a bed cover or a cab extension. This design is unique as the panels are being stored opening up the cab 130 while also being used as a bed cover. While FIG. 17 shows the panels 60 in a upward position but in an alternative embodiment the panel 60 may be lowered so they are resting on the sides of the bed covering the bed 130 making an expanded cab covering.

The Hardtop Slider Device and System can be in a kit form that can be added to any suitable vehicle 100,

The various features associate with the examples described herein and shown in the accompanying drawings can be implemented in different examples and implementations without departing from the scope of the present disclosure. Therefore, although certain specific constructions and arrangements have been described and shown in the accompanying drawings, such embodiments are merely illustrative and not restrictive of the scope of the disclosure, since various other additions and modifications to, and deletions from, the described embodiments will be apparent to one of ordinary skill in the art.

What is claimed is:

1. A device comprising:
a support with a top with an extender that connects to the top where a panel can be folded over the extender, where the support is connected to a track and the support could be moved forward or backward on the track.

2. A device according to claim 1 where the track is attached to the top of side of the bed.

3. A device according to claim 1 where the support can be moved back on the track with the panels to extend out to form a bed cover.

4. A device according to claim 3 where the panels are extended out on the extender.

5. A device according to claim 1 where the extender is parallel with top of a frame of a vehicle.

6. A device according to claim 1 where the support is as wide as the width of the bed of the vehicle.

7. A device according to claim 1 where the support has two sides and a back.

8. A device according to claim 1 where the support has a window.

9. A device according to claim 1 where the support is attached to the track by a track slider.

10. A device according to claim 1 where the support has two sides and a back.

11. A device according to claim 1 where the support is perpendicular to the bed.

12. A device according to claim 1 where the track has track lines.

13. The system comprising:
using the device of FIG. 1.

13. tem according to claim 13 where the track is attached to the top of side of the bed.

15. A system according to claim 13 where support can be moved back on the track with the panels to extend out to form a bed cover as shown.

16. A system according to claim 13 where the support has two sides and a back.

17. A system according to claim 13 where the support has a window.

18. A system according to claim 13 where the support is attached to the track by a track slider.

19. A system according to claim 13 where the support has two sides and a back.

20. A device comprising:
a support with a top with an extender that connects to the top where a panel can be folded over the extender, where the support is connected to a track and the support could be moved forward or backward on the track, where the track is attached to the top of side of the bed, where support can be moved back on the track with the panels to extend out to form a bed cover.
